(19) United States
(12) Patent Application Publication
(10) Pub. No.: US 2003/0110142 A1
(43) Pub. Date: Jun. 12, 2003

(54) Feed forward mail load notification system and method

(76) Inventors: Robert Sesek, Meridian, ID (US); Clay Higgins, Corvallis, OR (US); Donald Ouchida, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/022,142

(22) Filed: Dec. 12, 2001

(51) Int. Cl. G06F 17/00; G07B 17/02

(52) U.S. Cl. 705/404

(57) ABSTRACT

A method and apparatus for feed forward mail load notification to a mail carrier in a mass mailing operation. Various aspects of the production of mail pieces are monitored and a forecast is provided to the carrier. Aspects monitored include scheduling, consumable levels, manpower, equipment maintenance, planned and unplanned downtime and so forth. The information is correlated into a forecast and provided to the carrier on a routine basis, enabling the carrier to react accordingly. In a closed loop implementation, the carrier provides feedback related to its responsiveness to the forecast, and the mass mailer adapts accordingly. The mass mailing operation is contiguously monitored, and the forecast is updated when events cause expected production to deviate from the current forecast. Thus, the carrier is notified at the earliest time of the mail piece load to be expected from the mass mailer.

### BACKGROUND OF THE INVENTION

1. Field of the Invention

The present invention relates to communication systems. More specifically, the present invention relates to systems and method for effecting communication of load requirements.

2. Description of the Related Art

Delivery of packages and letters can be effected by affixing a destination address and suitable postage, or other indicia of payment, to an item and depositing it with a carrier such as the United States Postal Service (“USPS”) or other mail or package delivery service provider, such as Federal Express, Airborne Express, United Parcel Service, and etc. Mail and package delivery services are utilized by individuals on a piece by piece basis, and they are also utilized by businesses and organizations for mass mailing operations. Examples of mass mailing operations are the printing and distribution of periodic catalogs by a retailer, a regional mailing of discount coupons by an auto repair garage, flyers for a club or organization, magazine distribution to subscribers, shipment of packaged goods from a mail order house, and many others.

A mass mailing operation can be implemented by a company desiring to mail large numbers of letters and packages or such a company may contract with a mass mailing operator (a “mass mailer”) to do the printing and mailing. Mass mailers offer greater efficiency, lower cost, and higher reliability to the companies employing their service. A mass mailing operation generally includes the packaging of mail pieces, the weighing, and the affixation of postage or indicia of postage thereto, and the conveyance of the mail pieces to one or more carriers. Mass mailers may also offer printing services. The mail pieces may be letters or packages. The required postage or payment for delivery may be stanps, postage meter indicia, electronic stamps, or the shipper's account number for a carrier. The amount of postage is dependent upon the size of the mail item, the weight of the mail item, the destination of the mail item, and the service rate that applies to the item. One advantage of mass mailing operations is that certain economies of scale are realized to reduce mailing costs. In addition to the volume purchasing of consumable materials, and the operation of efficient volume mailing and processing machinery, the economies of scale are realized because such a mass mailing operation has access to preferential postage rates through various presorting and marking operations. These include 3-digit and 5-digit ZIP code sorting, barcode marking, postal route carrier sorting, and many other presorting alternatives provided for in the USPS regulations, and by private mail carrier services. Further discounts for postage rates are available depending on how the mail pieces are delivered to the carrier, including bulk, tray sorted, pallet sorted and others.

In a mass mailing operation, there are many variables that factor into the production rates achievable over any given period of time. Consumables, such as paper, envelopes, boxes, ink, toner and so forth must be kept in inventory at reasonable levels. Adequate processing machinery is needed for the production requirements, and spare parts and maintenance need to be planned for. Manpower is required to operate the equipment, and of course an inflow of business is needed to provide a steady production demand. Also required is an arrangement with the USPS or other delivery service that conveys the mail pieces from the mass mailer to the carrier.

In many applications, mail pieces are conveyed from the mass mailer to the USPS or other carrier through dispatch of a truck by the USPS or the carrier to the mass mailer's production facility. Of course, the capacity of the truck as well as the capacity of the USPS office or other carrier office to accept the mail piece volume output of the mass mailer need to be coordinated.

In the prior art, the de facto means for this coordination has been the ordinary business routine of the mass mailer. Generally, assuming the mass mailer has a steady inflow of business, the production rate is set by the capacity of the mass mailing machinery available. The USPS or carrier adapts to this capacity by routing the appropriate size and/or number of trucks to retrieve the daily production from the mass mailer. However, it is common for the actual production rate to vary from day to day.

An increase in business for the mass mailer may cause an occasional implementation of an additional shift or an increase in the number of machines to increase capacity. A breakdown, or maintenance down-time, for some of the mailing machines may reduce output. A reduction in business may cause a resultant reduction in mail piece output for a period of time. Any of these events, and many other events or business factors, can result in a significant change in the output volume in the number and/or weight of mail pieces.

If the USPS or carrier is not notified of such changes, they will not make adjustments in anticipation thereof. This can cause excess capacity to be allocated to the expected volume, which capacity may have been directed to other efforts had the change been anticipated. Or, where there is an increase in output, this can lead to an inadequate capacity allocation with respect to the volume of mail. This may result in a delay in the distribution of the mail and a backlog in inventory of the mass mailer. In any case, the lack of coordination results in inefficiencies, increased costs, and delays in ultimate mail processing and delivery.

Thus there is a need in the art for a system and method for coordinating mail processing between mass mailers and mass mailing operations and the USPS or other deliver services.

### SUMMARY OF THE INVENTION

The need in the art is addressed by the methods and apparatus taught by the present invention. In accordance with the inventive method, mail load notification is fed forward to a carrier in a mass mailing operation, thus allowing the carrier to anticipate and adapt to the mail load instead of merely reacting to it. Generally, the inventive method includes the steps of monitoring mail production and producing a mail load forecast to the carrier. Then, notifying the carrier of a change in the mail load forecast, if the monitoring operation indicates a variance in advance of the actual mail production. In a refinement to the method, the steps of receiving feedback from the carrier related to the carrier's capacity to accept mail and adjusting mail production in response to the feedback are added. An alternative to this refinement is to contact an alternative carrier and request that the excess production be accepted by the alternative carrier.

In other refinements to the foregoing method, the monitoring step includes the step of monitoring a mail production schedule, production history, present mail inventory levels, an equipment maintenance schedule, and/or the present mail production rate. In a further refinement, the mail load forecast is resolved to daily production forecasts. In a further refinement, the mail load forecast is a rolling forecast that is updated periodically. In other refinements, the mail load forecast indicates the total number of mail pieces, the total weight of mail pieces, the destination of mail pieces, and/or the routing of mail pieces. In a further refinement, the mail load forecast is communicated to the carrier via the Internet. In a further refinement, the mail load forecast is communicated to the carrier via a private network. In a further refinement, the mail load forecast is communicated to the carrier telephonically.

The present invention also teaches a system for feeding forward mail load notification to a carrier in a mass mailing operation. The inventive system includes an arrangement for monitoring mail production, an arrangement for producing a mail load forecast to the carrier, and an arrangement notifying the carrier of a change in the mail load forecast if the arrangement for monitoring indicates a variance in mail production. In a refinement of this apparatus, an arrangement for receiving feedback from the carrier related to the carrier's capacity to accept mail, and an arrangement for adjusting mail production in response to the feedback are added.

In a refinement to the foregoing apparatus, the arrangement for monitoring is adapted to monitor a mail production schedule, production history, the present mail inventory, an equipment maintenance schedule, and/or a present mail production rate. In a further refinement, the mail load forecast is resolved to daily production forecasts. An arrangement is disclosed that outputs a mail load forecast that is a rolling forecast updated periodically. The mail load forecast may indicate the total number of mail pieces, the total weight of mail pieces, the destination of mail pieces, and/or the routing of mail pieces. In a further refinement, an arrangement is disclosed to effect communication of the mail load forecast to the carrier via the Internet, a private network, or via telephonic means.

### BRIEF DESCRIPTION OF THE DRAWINGS

FIG. 1 is a block diagram of an illustrative embodiment of the present invention.

FIG. 2 is a flow diagram of an illustrative embodiment of the present invention.

FIG. 3 is a flow diagram of an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

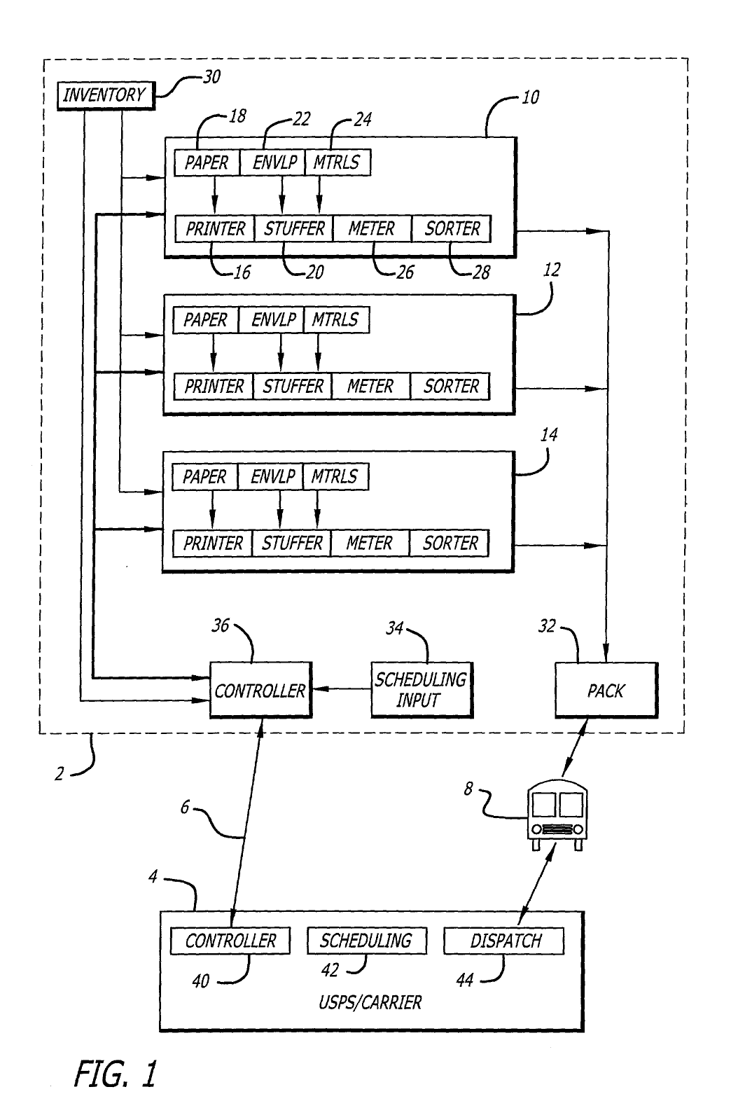

Reference is directed to FIG. 1, which is a block diagram of a mass mailing operation 2 employing an illustrative embodiment of the present invention. The mass mailing operation 2 may be operated by a business entity engaged in distribution of mail pieces for its own benefit, or it may be operated as a mass mailing business that provides such services for others. In either case, the operation 2 may be referred to as a “mass mailer” or “mass mailing operation.” Mass mailers 2 utilize machinery, supplies, consumables, and labor to produce quantities of mail pieces, (letters and packages), that are conveyed 8 to the USPS, the national mail carrier of a foreign nation, or other public and private carriers (collectively “carrier”) 4 for subsequent distribution and delivery.

The mass mailer 2 operates one or more mail preparation machines, three of which 10, 12, and 14 are illustrated in FIG. 1. The machines vary in configuration dependent upon the mail preparation task at hand, and, the structure illustrated in FIG. 1 is by way of example only. Those skilled in the art will appreciate that other configurations are equally suitable to the teachings of the present invention. In the illustrative embodiment, the mail machines are exemplified by mail machine 10. Mail machine 10 comprises a printer 16, which may be an inkjet printer, laser printer, offset printer or other suitable printer. A paper supply 18 is coupled to feed paper to the printer 16. The output of the printer is coupled to a stuffing machine 20 that receives the printed materials from the printer 16 and folds or otherwise combines these with envelopes or other materials. In the illustrative embodiment, a supply of envelopes 22 is coupled to supply envelopes to the stuffing machine 20. Stuffing machines are generally understood by those of ordinary skill in the art. In addition to the printed media supplied from the printer 16 to the stuffing machine 20, other pre-printed materials 24 are fed to the stuffing machine 20 to be folded and otherwise combined into the envelopes. The stuffed envelopes are fed to a postage weighing and metering machine 26, which weighs the mail item and imprints postage or indicia of postage thereunto. The mail pieces are next fed to a sorting machine 28 that assembles the mail pieces according to a predetermined order. The sorted mail is output from mail machine 10 and is subsequently combined with mail pieces output from mail machine 12 and mail machine 14. The combined mail from the plurality of machines is further packed by packing machine 32. The packing may be into trays, baskets, pallets, or other suitable form for delivery to the carrier in accordance with a pre-arranged agreement between the mass mailer and the carrier. Those skilled in the art appreciate the variety of packing options available. In order for the mass mailer to operate a plurality of mail machines, an inventory 30 of consumable materials, such as paper, ink, envelopes, and etc. must be maintained. Such an inventory is maintained through the routine business procedures of purchasing, ordering, lead-time management, and inventory management.

A strong influence on the operation of a mass mailer is the cost of postage required to mail the mail pieces. The USPS maintains various complex postage rate tables as an incentive to mass mailers to assist the USPS in efficiently receiving, distributing, and delivering mail pieces. Other national mail services and private carriers engage in similar pricing incentives. Those skilled in the art are familiar with such incentives, and realize that they change from time to time with market forces and evolutions of technology. By way of example and not limitation, incentives are provided for sorting according to three of the five ZIP code's digits, five of the five ZIP code's digits, ZIP+4 coding, for applying scannable barcodes for automated mail routing and delivery machines, for sorting to the postal carrier routes, and so forth. The sorting machines 28 in each of the mail machines 10, 12, and 14 implement the sorting function, which is coordinated with the packing machine 32 operation. A part of this operation is the affixation of labels to bundles, trays, baskets, and pallets indicative of the hierarchy of sorting that has been applied to the respective contents. In the illustrative embodiment mass mailing operation 2, a controller 36 is employed to operate and coordinate the various components of the mass mailing operation 2. The controller 36 may be a personal computer or other form of industrial computer as are utilized by those skilled in the art of industrial control.

The controller 36 is coupled to the mail machines 10, 12, and 14 and controls the operation of each machine. This control includes the provision of mailing addresses to the mail pieces, and the general operation of the machines, as is understood by those skilled in the art. The mailing addresses are pre-sorted by the controller 36 so that the mail is produced in an order consistent with the desired sorted output. In addition, the controller is coupled to determine the reserve levels of consumable materials from the inventory 30. A mass mailer 2 typically processes several different mailing jobs in a given shift, so there is coordination among the various jobs being processed by the mass mailer. The interface between the controller 36 and the mail machines 10, 12, and 14 includes a plurality of control outputs and sensory inputs. By way of example and not limitation, the control outputs include the provision of address information to the mailing machines 10, 12, and 14 the enablement and disablement of the various sub-machines, control of the rate of production and interface among the various components, and etc. Also by way of example and not limitation, the sensory inputs to controller 36 include the level of consumable materials, such as the paper reserve 18, the envelope reserve 22, the materials reserve 24, as well as ink, toner, and postage levels. In addition, the sensory inputs include information about paper and product jams, production rates, online/offline status, and other parameters as are understood by those skilled in the art.

According to the illustrative embodiment, during a shift of operation, the controller 36 directs the machines to produce mail pieces and to sort and pack them as well. The controller is operable to maintain a record of the produced mail pieces. When consumable reserve levels become low, a notice is provided to replenish supplies from the inventory 30. The controller is operable to sense reserve and inventory levels and to calculate the number of mail pieces that will fully deplete reserves. In the case where the reserves or inventory are inadequate, the controller is operable to calculate the time until reserves are depleted and production is no longer possible until such time as new materials are reordered and received. The controller also receives scheduling input 34 that is communicated from an operator or another system.

As mass mailing projects are input to the mass mailing system 2, for example through the process of selling the services into the marketplace, orders are input into the scheduling input 34 that include various specifications. Order specifications may include, for example, a specification of the materials to be supplied, the content of printed pages to be stuffed, envelope specifications, quantity and addresses of the mail pieces to be produced, the level of sorting detail, the date the mail pieces are to be conveyed to the carrier, the cost, sales price and profitability of the job, and many other factors, as are understood by those skilled in the art. The controller then correlates the various jobs input to the system and generates a schedule of jobs, taking into account the resources available and the specifications of the orders. The schedule may have user inputs, and in some cases may be entirely user created. In any event, the schedule represents a forecast of the production over a period of time into the future. Past performance is an indication of future capacity, so this is factored into the scheduling operation. For example, past performance may indicate that typical machine down time is 5%, so capacity is set at 95% of machine capacity so that reasonably accurate forecasts and scheduling are possible. Scheduling is important for a variety of reasons. In addition to the typical business purposes of planning sales, purchasing, hiring and manpower, operational, and capital factors, the schedule is important in the illustrative embodiment for coordination of the conveyance of mail pieces to the carrier 4.

The capacity and resources expended in production of mail pieces necessarily must mesh with the conveyance to the carrier and subsequent distribution and delivery. In the prior art, mass mailers have established a course of business that has largely been based upon production capacity and prior trends. The carrier has adapted to this reality by routinely dispatching a daily truck (or trucks) to the mass mailer for collection of the daily mail piece production. As noted herein before, this approach is limited in that it does not address variation in production. In the event there is a shortage of consumables or there is a breakdown of machines at the mass mailer, then the production will be reduced. The carrier follows its routine and dispatches a truck sufficient in capacity for the expected mail piece production. This results in a waste of resources, such as too large a truck being dispatched, and/or too may employees awaiting the mail piece influx. In response to the shortage on the first day, for example, the mass mailer may implement a second catch-up shift, which results in an increase in mail piece output on the subsequent day. Yet, the carrier again follows the routine and the dispatched truck is inadequate for the increased production. In some cases, the mass mailer may contact the USPS or carrier by telephone and notify them of the variation in production, but this usually occurs after the fact, when it is not possible for a suitable adjustment to be made. The present invention dramatically improves upon this situation by enabling a feed forward communications link between the mass mailer and the USPS or carrier. This, in turn, allows the mass mailer to improve its relationship with the carrier and can provide leverage for advantageous rate negotiations.

Again referring to FIG. 1, the controller 36 utilizes the aforementioned sensory inputs and scheduling inputs and correlates this information to produce a schedule. The schedule can include a high level of detail. This can include the number of mail pieces, the weight of the mail pieces, the number of address destinations, the sorting detail and other technical factors, as are understood by those skilled in the art. The schedule is routinely conveyed to a controller 40 at the carrier. The controller 40 may be a computer system, but could an individual responsible for control and scheduling at the carrier. Within the carrier, a scheduling task 42 receives the forecast information and plans dispatch 44 so that the appropriate vehicular capacity 8 is provided on each pick up run. Of course, the internal operations and capacities in the USPS or other carrier 4 are also adapted to the forecast. A schedule, like a weather forecast, improves in accuracy as the scheduled events become closer in time. Thus, the implementation of a rolling schedule is useful. In the illustrative embodiment, a rolling schedule for the upcoming month is produced. The rolling schedule is based on information from the scheduling inputs 34 and also in inventory levels, maintenance plans, and production schedules for holidays, business interruptions and so forth. The schedule is conveyed 6 to the USPS or other carrier. Conveyance may be via telephonic communications, the Internet or a private network, such as an intranet. Each day, the rolling forecast is updated to include production changes, new business, altered production priorities and so forth. This keeps the near term forecast as accurate as possible.

The controller 36 also monitors for other potential interruptions in business, such as scheduled maintenance, shortages of consumables, manpower shortages, and other effects on production. Even in the case where an interruption is noted just a few hours before the effect thereof is realized, the controller 36 is able to notify the carrier controller 40 of the variations so that some accommodation can be made. This system operates open-loop in that it provides the information to the carrier and it allows the carrier to use it as deemed appropriate. In another alternative illustrative embodiment, the controller 36 receives feedback from the carrier controller 40, which is used to adapt future production in accordance therewith. For example, if there is a shortfall in production on a first day, and a planned increase to cover on the following day, the controller 36 would send such a notification to the carrier. The feed back may be that the carrier was not able to increase pick-up capacity for the following day. The controller 36 would use this information to prioritize the following day production to optimize customer requirements, profitability, deadlines, and so forth. This is an example of a closed-loop implementation of the present invention. The operation of the foregoing system is more readily apparent with reference to the following discussions regarding the illustrative processes of the present invention.

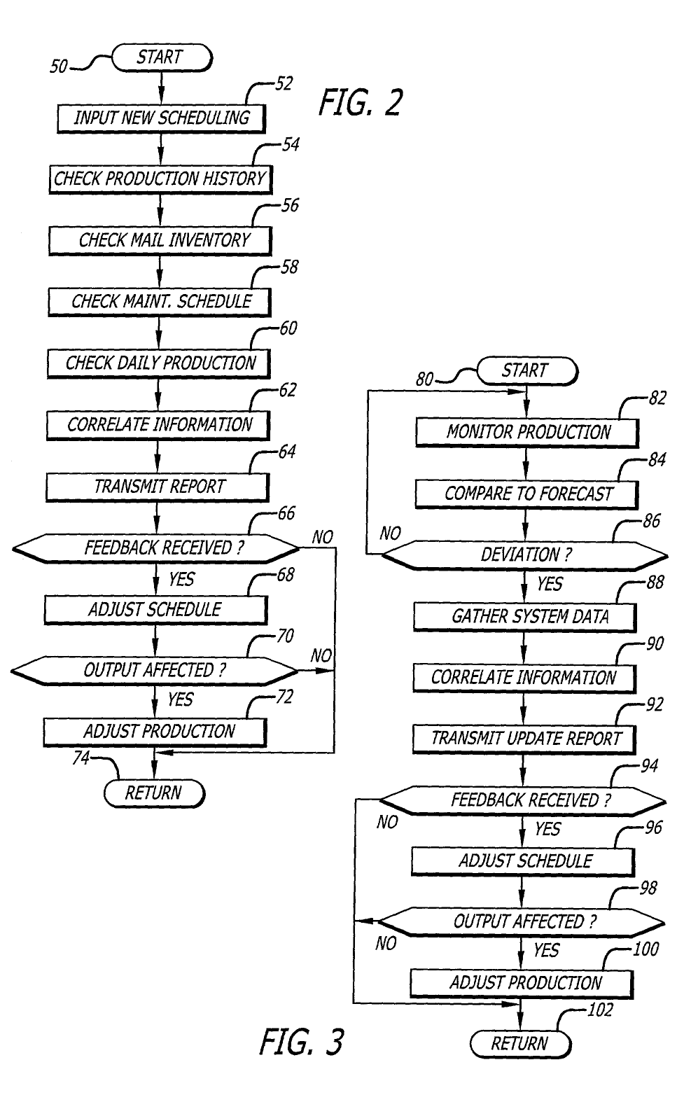

Reference is directed to FIG. 2, which is a flow diagram of an illustrative embodiment of the present invention. The process begins at step 50 and proceeds to step 52 where new scheduling information is input into the controller. At step 54, the controller checks the production trends, as this is an indication of future production capacity. Then, at step 56, the controller checks the current mail piece inventory, which is important for determining the present and subsequent day mail piece loads that will be conveyed to the carrier. At step 58, the maintenance schedule is checked for a determination if any machines will be taken out of service, thus reducing production capacity. At step 60, the current daily production rates and levels are checked, and this is the most accurate information available as these represent actual numbers and not forecasts. At step 62, all of the gathered information is correlated to produce a forecast for the present day, the subsequent day, and with gradually decreasing confidence, all of the subsequent days for the following thirty day period. Once correlated, a report is generated and transmitted to the carrier at step 64. This represents the open loop routine forecasting operation according to the illustrative embodiment of the present invention. However, in the case of a closed loop implementation, the process continues to step 66 where it awaits feedback from the carrier. If feedback is not received the process returns at step 74. On the other hand at step 66, if feed back is received from the carrier, then the schedule is adjusted at step 68 according to the limitations put in place by the carrier. An alternative approach is also implemented at step 68. The process contacts an alternative carrier and requests that the excess production be accepted by the alternative carrier. These limitations are tested at step 70 to determine if output capacity must be affected to accommodate the limitations. Note that if the alternative carrier accepted the excess production at step 68, then the output is not affected at step 70. Therefore, if output is not affected at step 70, then flow returns at step 74. On the other hand at step 70, if output is to be limited, then production is adjusted at step 72, including the necessary prioritization, and flow returns at step 74.

FIG. 3 illustrates the process flow in the case where a deviation from plan is realized during routine production. This process begins at step 80 and proceeds to step 82 where the aforementioned production variables are monitored, typically through sensory input to the controller. The monitored information is compared to the forecast at step 84. At step 86, a test for any significant deviation is conducted. If no deviation is found, then flow recirculates to step 82 to continue the monitoring process. On the other hand at step 86, if a deviation is noted, then the pertinent system information is gathered at step 88 and then correlated to formulate a best estimate of the daily production forecast at step 90. A similar approach as discussed herein before is applied at this step. At step 92, the updated report is transmitted to the carrier. This represents the open loop deviation forecasting operation according to the illustrative embodiment of the present invention. However, in the case of a closed loop implementation, the process continues to step 94 where it awaits feedback from the carrier. If it is not received the process returns at step 102. On the other hand at step 94, if feed back is received from the carrier, then the schedule is adjusted at step 96 according to the limitations put in place by the carrier. An alternative approach is also implemented at step 96. The process contacts an alternative carrier and requests that the excess production be accepted by the alternative carrier. These limitations are tested at step 98 to determine if output capacity must be affected to accommodate the limitations. Note that if the alternative carrier accepted the excess production at step 96, then the output is not affected at step 98. Therefore, if output is not affected at step 98, then flow returns at step 102. On the other hand at step 98, if output is to be limited, then production is adjusted at step 100, including the necessary prioritization, and flow returns at step 102.

Thus, the present invention has been described herein with reference to a particular embodiment for a particular application. Those having ordinary skill in the art and access to the present teachings will recognize additional modifications applications and embodiments within the scope thereof.

It is therefore intended by the appended claims to cover any and all such applications, modifications and embodiments within the scope of the present invention.

What is claimed is:

1. A method of feed forward mail load notification to a carrier in a mass mailing operation, comprising the steps of:
monitoring mail production;
producing a mail load forecast to the carrier, and
notifying the carrier of a change in said mail load forecast if said monitoring step indicates a variance in mail production.

2. The method of claim 1 further comprising the steps of:
receiving feedback from the carrier related to the carrier's capacity to accept mail and
adjusting mail production in response to said feedback.

3. The method of claim 1 further comprising the steps of:
receiving feedback from the carrier related to the carrier's capacity to accept mail and
requesting the services of a second carrier to accept excess production in the event the carrier is unable to accept the entire mail load production.

4. The method of claim 1 wherein said monitoring step comprises monitoring a mail production schedule.

5. The method of claim 1 wher ein said m onitoring step comprises monitoring production history.

6. The method of claim 1 wherein said monitoring step comprises monitoring present mail inventory.

7. The method of claim 1 wherein said monitoring step comprises monitoring an equipment maintenance schedule.

8. The method of claim 1 wherein said monitoring step comprises monitoring a present mail production rate.

9. The method of claim 1 wherein said mail load forecast is resolved to daily production forecasts.

10. The method of claim 1 wherein said mail load forecast is a rolling forecast that is updated periodically.

11. The method of claim 1 wherein said mail load forecast indicates the total number of mail pieces.

12. The method of claim 1 wherein said mail load forecast indicates the total weight of mail pieces.

13. The method of claim 1 wherein said mail load forecast indicates the destination of mail pieces.

14. The method of claim 1 wherein said mail load forecast indicates the routing of mail pieces.

15. The method of claim 1 wherein said mail load forecast is communicated to the carrier via the Internet.

16. The method of claim 1 wherein said mail load forecast is communicated to the carrier via a private network.

17. The method of claim 1 wherein said mail load forecast is communicated to the carrier telephonically.

18. An apparatus for feeding forward mail load notification to a carrier in a mass mailing operation, comprising:
means for monitoring mail production;
means for producing a mail load forecast to the carrier; and
means for notifying the carrier of a change in said mail load forecast if said
means for monitoring indicates a variance in mail production.

19. The apparatus of claim 18 further comprising:
means for receiving feedback from the carrier related to the carrier's capacity to accept mail and
means for adjusting mail production in response to said feedback.

20. The apparatus of claim 18 further comprising:
means for receiving feedback from the carrier related to the carrier's capacity to accept mail and
means for requesting the services of a second carrier to accept excess production in the event the carrier is unable to accept the entire mail load production.

21. The apparatus of claim 18 wherein said means for monitoring monitors a mail production schedule.

22. The apparatus of claim 18 wherein said means for monitoring monitors production history.

23. The apparatus of claim 18 wherein said means for monitoring monitors present mail inventory.

24. The apparatus of claim 18 wherein said means for monitoring monitors an equipment maintenance schedule.

25. The apparatus of claim 18 wherein said means for monitoring monitors a present mail production rate.

26. The apparatus of claim 18 wherein said mail load forecast is resolved to daily production forecasts.

27. The apparatus of claim 18 wherein said mail load forecast is a rolling forecast that is updated periodically.

28. The apparatus of claim 18 wherein said mail load forecast indicates the total number of mail pieces.

29. The apparatus of claim 18 wherein said mail load forecast indicates the total weight of mail pieces.

30. The apparatus of claim 18 wherein said mail load forecast indicates the destination of mail pieces.

31. The apparatus of claim 18 wherein said mail load forecast indicates the routing of mail pieces.

32. The apparatus of claim 18 wherein said mail load forecast is communicated to the carrier via the Internet.

33. The apparatus of claim 18 wherein said mail load forecast is communicated to the carrier via a private network.

34. The apparatus of claim 18 wherein said mail load forecast is communicated to the carrier telephonically.
